(19) United States
(12) Patent Application Publication
(10) Pub. No.: US 2025/0174081 A1
(43) Pub. Date: May 29, 2025

(54) CONTROLLING GAMING ESTABLISHMENT CREDIT SYSTEM ISSUED LINE OF CREDIT ACTIVATIONS BASED ON SPEND

(71) Applicant: IGT, Las Vegas, NV (US)

(72) Inventors: Jeffery Shepherd, Reno, NV (US); Kevin Higgins, Reno, NV (US)

(21) Appl. No.: 19/034,225

(22) Filed: Jan. 22, 2025

Related U.S. Application Data
(63) Continuation of application No. 17/125,455, filed on Dec. 17, 2020.

(51) Int. Cl. G07F 17/32

(52) U.S. Cl. CPC G07F 17/3244

(57) ABSTRACT

A system that accounts for different channels of commerce in offering a line of credit to a gaming establishment patron and/or enabling the gaming establishment patron the opportunity to activate funds associated with an issued line of credit.

### PRIORITY CLAIM

This application is a continuation of, claims priority to and the benefit of U.S. patent application Ser. No. 17/125,455, filed on Dec. 17, 2020, the entire contents of which is incorporated by reference herein.

### BACKGROUND

In various embodiments, the systems and methods of the present disclosure account for different channels of commerce in offering a line of credit to a gaming establishment patron and/or enabling the gaming establishment patron the opportunity to activate funds associated with an issued line of credit.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIG. 1 is an example configuration of the architecture of a plurality of different components of the system of the present disclosure.

FIGS. 2A, 2B, and 2C are example graphical user interfaces displayed in connection with a mobile device application and pertaining to spending controls affecting available actions associated with a line of credit.

FIG. 3 is a schematic block diagram of one embodiment of an electronic configuration of an example electronic gaming machine.

FIGS. 4A and 4B are perspective views of example alternative embodiments of an example electronic gaming machine.

### DETAILED DESCRIPTION

In various embodiments, the system of the present disclosure accounts for one or more spending controls in offering lines of credit and/or enabling the activation of funds associated with issued lines of credit.

In certain embodiments, the system determines one or more parameters associated with an issuance of a line of credit or marker for a user based on how the funds associated with that line of credit will potentially be used. In these embodiments, following a user applying for a line of credit with a gaming establishment credit system, the system determines one or more spending controls associated with the applied for line of credit, wherein such spending controls determine one or more channels of commerce at which funds from the line of credit may or may not be spent at. In different embodiments, in determining whether to accept an application for a line of credit by a gaming establishment patron and/or whether to associate any spending restrictions on a line of credit for a gaming establishment patron, the system analyses historical spending activity of the gaming establishment patron at the gaming establishment and/or anticipated spending activity of the gaming establishment patron at the gaming establishment and determines, based on this analysis, an amount, if any, to approve for the line of credit subject to any restrictions on the use of that amount. For example, upon determining that a gaming establishment patron (whom has applied for a line of credit with the gaming establishment) historically spends the majority of their gaming establishment spend on non-gaming activities, such as food and beverage purchases, and in an effort to reduce risk of default on funds loaned to gaming establishment patrons for non-gaming purposes, the system determines not to offer that gaming establishment patron the applied for line of credit. In another example, upon determining that a gaming establishment patron (whom has applied for a line of credit with the gaming establishment) historically spends the majority of their gaming establishment spend on gaming activities, such as placing sports wagers, and in an effort to enable that gaming establishment patron to realize relatively larger gaming activity wins by having access to a relatively larger pool of available funds, the system determines to approve the applied for line of credit with a spending control dictating that the majority of such funds of the line of credit be activated for gaming activities.

In certain embodiments, in addition to or alternative from determining one or more parameters associated with the issuance of a line of credit or marker for a user, the system determines whether or not to activate funds from the line of credit or marker based on how the funds from the line of credit will be spent relative to any spending controls associated with the line of credit. In these embodiments, following the gaming establishment credit system issuing a user, such as a player, a line of credit associated with zero, one or more spending controls and responsive to a request by the user to activate an amount of funds from the line of credit, the system determines if the activation of such funds complies with any spending controls associated with the line of credit.

If the system determines that the activation of such funds complies with any spending controls associated with the line of credit, the system proceeds with activating the requested amount of funds. For example, if a user has been issued a $5,000 line of credit associated with a spending control that no more than $500 may be activated for use at a retail establishment associated with the gaming establishment, following the user attempting to activate $2,500 from the line of credit via a gaming table component associated with a gaming table, the system identifies the use of the funds from the line of credit as a gaming channel (i.e., the system identifies the gaming table component as part of a gaming establishment gaming channel) and activates $2,500 from the line of credit (to be provided to the user at the gaming table associated with the gaming table component).

On the other hand, if the system determines that the activation of such funds would violate one or more spending controls associated with the line of credit, the system does not activate the requested amount of funds (or enables the user to modify one or more aspects of the request to comply with the spending controls, such as modifying the requested amount of funds and/or modifying the terms associated with the line of credit). For example, if a user has been issued a $5,000 line of credit associated with a spending control that no more than $500 may be activated for use at a retail establishment associated with the gaming establishment, following the user attempting to activate $1,000 from the line of credit at a retail establishment, the system identifies the use of the funds from the line of credit as a retail channel (i.e., the system identifies a point-of-sale terminal of the retail establishment as part of a gaming establishment retail channel) and denies the activation of the $1,000 from the line of credit (or alternatively enables the user to modify the requested amount to be activated to $500).

Accordingly, in view of the various channels of commerce present throughout a gaming establishment and additionally in view of funds activated from lines of credit being at different risks of default based on which channels of commerce the funds are used in, the system of the present disclosure accounts for such channels of commerce in determining the approval of such lines of credit and/or the activation of funds from such lines of credit. That is, by factoring in one or more spend characteristics in offering lines of credit and/or activating funds from issued lines of credit, the system increase the flow of money throughout a gaming establishment without correspondingly increasing the risks of default on such lines of credit. Put differently, since certain gaming establishment patrons are uncomfortable venturing into a gaming establishment with large amounts of cash as well as many gaming establishment patrons being relatively cash poor (e.g., patrons may have a relatively high net worth but most of their net worth may be tied up in various illiquid investments or assets which they are reluctant to sell to raise cash for gambling), the system provides such gaming establishment patrons access to funds in the form of lines of credit with certain spending controls or restrictions on how the funds may be used to reduce the chances that such gaming establishment patrons not honoring the terms of such lines of credit. Such a utilization of one or more lines of credit or markers paired with one or more spending controls provides such relatively cash poor gaming establishment patrons with the availability of an amount of funds without exposing the gaming establishment credit system to substantially increased risks of making such funds available.

### System Accounts

In various embodiments, the present disclosure is directed to a gaming establishment fund management system including various components or sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a player and/or retail patron, collectively form a resort or enterprise account (i.e., an integrated resort or gaming establishment fund management wallet) that the user may access to transfer funds and/or view balance information amongst the various accounts associated with or otherwise maintained for the user.

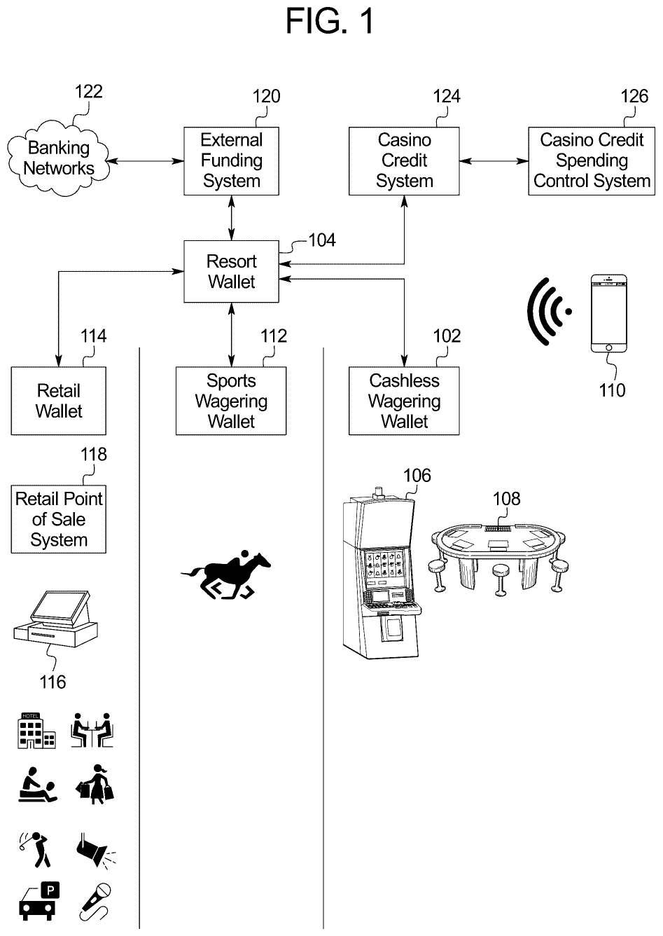

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes a first cashless wagering system that maintains a first cashless wagering account. In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a player tracking unit associated with the EGM) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the resort wallet 104. In this example, to facilitate the transfer of funds from this cashless wagering account to a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the resort wallet 104. In this example, to facilitate the transfer of funds from this cashless wagering account to a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. Such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the resort wallet 104. In this example, to facilitate the transfer of funds from this gaming establishment retail account to an account associated with a retailer to purchase goods and/or services from the retailer, the system utilizes a retail wallet identity, such as a mobile device 110 running a mobile device application that interfaces with a point-of-sale terminal 116 of a retail point-of-sale system 118 of the retailer, and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a retailer.

It should be appreciated that in various embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In certain embodiments, the gaming establishment fund management system is in communication with one or more external funding sources which maintain one or more external accounts for the user. For example, as seen in FIG. 1, the gaming establishment fund management system that maintains the resort wallet 104 is in communication with an external funding system 120 which is in communication with a network of one or more banks or other financial institutions (i.e., the banking networks 122) which operate to electronically transfer funds to/from the user's accounts maintained at such banks or financial institutions to/from one or more of the accounts maintained by the gaming establishment fund management system. In certain embodiments, such external accounts include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that while illustrated as the gaming establishment fund management system being in communication with one or more external funding sources, in different embodiments, any component or sub-system of the present disclosure can be in communication with one or more external funding sources. In different embodiments, the system utilizes a mobile device running a mobile device application, a kiosk, a gaming device, a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system is in communication with one or more credit systems which each issue the user one or more lines of credit or markers associated with zero, one or more spending controls or restrictions. For example, as seen in FIG. 1, the gaming establishment fund management system that maintains the resort wallet 104 is in communication with a gaming establishment credit system (i.e., the casino credit system 124) to facilitate the establishment of an amount of funds in the gaming establishment fund management account via one or more lines of credits. In this example, to facilitate a transfer of funds from the line of credit issued by the credit system to a cashless wagering account (and then to a credit balance of an EGM 106 and/or a credit balance of a gaming table component (not shown) associated with a gaming table 108) and/or to facilitate a transfer of funds from the line of credit issued by the credit system to a gaming establishment retail account (and then to a point-of-sale terminal 116 of a retail point-of-sale system 118 of a retailer), the system utilizes a mobile device 110 running a mobile device application that interfaces with one or more components of the credit system to enable a user, such as a player of the EGM or a player at the gaming table, to apply for a line of credit and/or access an amount of funds associated with an issued line of credit in compliance with any associated spending controls. It should be appreciated that while illustrated as the gaming establishment fund management system being in communication with one or more credit systems, in different embodiments, any component or sub-system of the present disclosure can be in communication with one or more credit systems.

In certain embodiments, the credit systems which each issue the user one or more lines of credit or markers associated with zero, one or more spending controls or restrictions are in communication with or otherwise associated with one or more gaming establishment credit spending control systems. For example, as seen in FIG. 1, the gaming establishment credit system (i.e., the casino credit system 124) is in communication with a gaming establishment credit spending control system (i.e., casino credit spending control system 126) to ensure that one or more lines of credits issued and/or funds withdrawn from one or more issued lines of credit comply with one or more restrictions placed on the use of such funds. In one such embodiment, as shown, the gaming establishment credit spending control system is a separate system that operates with the gaming establishment credit system prior to issuing one or more lines of credit and/or enabling a user to activate any funds from one or more lines of credit. In this embodiment, the gaming establishment credit system interrogates the gaming establishment credit spending control system before granting a line of credit or letting a user borrow against the line of credit to determine whether or not any spending controls or restrictions are in place and if so, how such spending controls or restricts affect the potential action by the gaming establishment credit system. In another such embodiment (not shown), the gaming establishment credit spending control system is part of or otherwise built into the gaming establishment credit system and operates to enforce any spending controls or restrictions prior to issuing one or more lines of credit and/or enabling a user to activate any funds from one or more lines of credit. In this embodiment, before granting a line of credit or letting a user borrow against the line of credit, the gaming establishment credit spending control system (i.e., a component of the gaming establishment credit system) determines whether or not any spending controls or restrictions are in place and if so, how such spending controls or restricts affect the potential action by the gaming establishment credit system. It should be appreciated that while illustrated as the gaming establishment credit spending control system being in communication with (or otherwise integrated into) one or more credit systems, in different embodiments, any component or sub-system of the present disclosure can be in communication with one or more credit spending control systems.

In certain embodiments wherein the gaming establishment fund management system is in communication with one or more credit systems which each issue the user one or more lines of credit or markers having zero, one or more spending controls, the gaming establishment fund management system (and/or the gaming establishment credit system) maintains an outstanding line of credit balance or account which tracks the amount of funds owed to the gaming establishment credit system. In these embodiments, the gaming establishment fund management system maintains this outstanding line of credit balance or account to enable greater user flexibility in how they use the activated funds from a line of credit (when compared to a system that automatically pays back part or all of the funds from an activated line of credit with each cash out from each EGM). In such embodiments, since the activated line of credit need not be repaid with each cash out from each EGM (and thus remains outstanding until paid back upon an occurrence of a line of credit repayment event, such as when a scheduled transfer of funds from an external account is completed), the user can transition from one EGM to another EGM (or other gaming device) with complete access to the available amount of funds of the activated line of credit. That is, since the funds from a credit balance of an EGM are transferred to a gaming establishment account, such as a cashless wagering account, upon a cash out event at the EGM, such funds remain available for immediate use at another EGM (or another gaming device or another channel of commerce) without requiring the user to reactivate any lines of credit with any gaming establishment credit systems. Such a configuration provides a user greater control over the funds owed to the gaming establishment credit system under the activated line of credit.

In certain embodiments (not shown), the gaming establishment fund management system is also in communication with one or more credit reporting/credit risk systems which monitor and report on various accounts associated with the user. For example, the gaming establishment fund management system that maintains the resort wallet is in communication with one or more credit reporting and risk systems. These credit reporting and risk systems monitor and report on a credit rating and status of one or more accounts maintained for the user at various funding sources, such as various financial institutions. It should be appreciated that while illustrated as the gaming establishment fund management system being in communication with one or more credit reporting networks and one or more credit reporting/credit risk systems, in different embodiments, any component or sub-system of the present disclosure can be in communication with one or more credit reporting/credit risk systems.

In certain embodiments, the system utilizes one mobile device application to interact with the different components of the gaming establishment fund management system to access funds maintained in the different gaming establishment accounts associated with the user, to apply for one or more lines of credit and/or to access funds associated with one or more lines of credit or markers in compliance with any associated spending controls. For example, utilizing the same mobile application, a mobile device interacts with both the first cashless wagering system of the gaming establishment fund management system and the credit system in communication with the gaming establishment fund management system. In certain embodiments, the system utilizes multiple mobile device applications to interact with the different components of the gaming establishment fund management system to access funds maintained in the different gaming establishment accounts associated with the user, to apply for one or more lines of credit and/or to access funds associated with one or more lines of credit or markers in compliance with any associated spending controls. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

It should be appreciated that in different embodiments, in addition to or alternatively from utilizing a mobile device running a mobile device application to access funds associated with different gaming establishment accounts, to apply for one or more lines of credit and/or to access funds associated with one or more lines of credit in compliance with any associated spending controls, the system utilizes a kiosk, an EGM, a service window displayed by a gaming device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to access the funds associated with such gaming establishment accounts, to apply for one or more lines of credit and/or to access funds associated with one or more lines of credit in compliance with any associated spending controls. It should be further appreciated that while illustrated in FIG. 1 as using a mobile device running a mobile device application to access funds associated with different gaming establishment accounts (e.g., a cashless wagering account and a gaming establishment retail account), to apply for one or more lines of credit and/or to access funds associated with one or more lines of credit issued to the user, a physical instrument, such as a smart card or a user issued magnetic striped card may additionally or alternatively be utilized to enable a user access to such gaming establishment accounts, to apply for one or more lines of credit and/or to access funds associated with one or more lines of credit in compliance with any associated spending controls.

### Issuing A Line of Credit

In various embodiments, prior to activating any funds associated with an issued line of credit, a user, such as a player, must first open a line of credit or marker with the gaming establishment credit system. In these embodiments, utilizing an interface, such as a mobile device application being executed by a mobile device, a mobile website accessed from a browser of a mobile device and/or a service window displayed by EGM (or other gaming device), the user applies for a line of credit through one or more interactive forms. For example, as part of applying for a line of credit with a gaming establishment credit system, a user (whom has already logged into one or more gaming establishment fund management system accounts via a mobile device application) makes one or more inputs via an interface to provide certain user identifying information, such as, but not limited to, additional address details, a social security number and/or a mother's maiden name. In certain embodiments, in addition to providing certain user identifying information, as part of applying for a line of credit with a gaming establishment credit system, the user makes one or more inputs via an interface to provide certain anticipated spending information, such as how the user intends to spend the funds withdrawn from the line of credit if approved.

Following the providing of such information, in certain embodiments, the system determines whether any spending controls or restrictions need to factor into the potential opening of the applied for line of credit. In these embodiments, one or more components of or otherwise associated with the gaming establishment fund management system, such the gaming establishment credit spending control system, employ one or more spending controls in the determination of whether or not an applied for line of credit should be granted. In certain other embodiments, the system determines whether or not to grant the applied for line of credit independent of any spending controls, wherein, as described below, such spending controls factor into whether or not funds from an issued line of credit may be used for one purpose versus another.

In certain embodiments wherein one or more spending controls factor into the issuance of a line of credit, the gaming establishment credit spending control system determines if any spending controls are in place to prevent the gaming establishment credit system from accepting the applied for line of credit. For example, upon determining that a user previously used funds drawn from a previous line of credit in association with a non-gaming channel of commerce without using any funds in association with any gaming channels of commerce (which resulted in, based on gaming establishment operator policy, the gaming establishment credit spending control system employing a spending control for future lines of credit for the user), the gaming establishment credit spending control system alerts the gaming establishment credit system of such information to factor into whether to approve or deny the issuance of the applied for line of credit. In another example, upon determining that a user indicated an intention of using funds from the applied for line of credit exclusively in a gaming channel of commerce, the gaming establishment credit spending control system alerts the gaming establishment credit system of such information to factor into whether to approve or deny the issuance of the applied for line of credit. As seen in these examples, in certain instances, the gaming establishment credit spending control system enables the gaming establishment credit system to make relatively more informed decisions regarding whether or not to issue an applied for line of credit to a user.

In certain other embodiments wherein one or more spending controls factor into the issuance of a line of credit, the gaming establishment credit spending control system determines if any spending controls are in place to cause the gaming establishment credit system to modify one or more components of the applied for line of credit. For example, upon determining that a user previously used funds drawn from a previous line of credit in association with a first channel of commerce (which resulted in the gaming establishment credit spending control system placing a limitation on the amount of funds drawn from future lines of credit which may be used in that first channel of commerce), the gaming establishment credit spending control system alerts the gaming establishment credit system of such information to factor into whether to modify the terms of the applied for line of credit to comply with the gaming establishment credit spending control system placed spending control. In another example, upon determining that a user indicated an intention of using funds from the applied for line of credit exclusively on a non-gaming channel of commerce, the gaming establishment credit spending control system alerts the gaming establishment credit system of such information and any applicable spending controls in place to factor into whether to modify the requested amount of the applied for line of credit to comply with a lower amount in association with the non-gaming channel of commerce. As seen in these examples, in certain instances, the gaming establishment credit spending control system enables the gaming establishment credit system to make relatively more informed decisions regarding whether or not to modify any aspects of an applied for line of credit to a user.

In various embodiments, following the user applying for a line of credit with a gaming establishment credit system and following the gaming establishment credit system (and/or other component of the gaming establishment fund management system) obtaining information from the gaming establishment credit spending control system regarding any spending controls in place, the gaming establishment credit system determines one or more attributes of the applied for line of credit, such as determining whether to approve the applied for line of credit, determining an amount of credit to offer the user and/or determining any spending controls to associate with the line of credit. In these embodiments, a user's prior spending within zero, one or more channels of commerce of the gaming establishment and/or a user's indicated anticipated spending within zero, one or more channels of commerce of the gaming establishment factor into how the gaming establishment credit system handles an applied for line of credit, such as whether or not to issue the line of credit and/or place any restrictions on the use of funds from any issued line of credit.

If the system determines that the user is ineligible to be issued a line of credit from the gaming establishment credit system, the system denies the user the use of the requested amount of funds. That is, upon a line of credit disapproval event (which occurs, in certain embodiments, based at least in part on one or more spending controls in place), the system denies the application for the line of credit and thus does not enable the user to utilize the requested amount of funds of the denied line of credit. In these embodiments, the system proceeds with communicating a denial of a line of credit message to the user, such as via a mobile device application displaying a line of credit or marker denial to the user.

On the other hand, if the system determines that the user is eligible to be issued a line of credit from the gaming establishment credit system, the system approves an amount of funds in association with the applied for line of credit subject to any applicable spending controls. That is, upon a credit approval event (which occurs, in certain embodiments, based at least in part on one or more spending controls in place), the system approves the application of the line of credit subject to any restrictions on how the funds from the line of credit may be used within different gaming establishment channels of commerce, such as within a gaming vertical or within a retail space.

In certain embodiments, as indicated above, in approving an amount of funds available to the user from a line of credit, the system determines whether to associate any spending controls on the approved line of credit. In these embodiments, to account for different channels of commerce associated with a gaming establishment being more or less favorable (at least in terms of probabilities of default) to have funds from a line of credit used at, the system may or may not apply one or more spending controls to the approved line of credit to limit, permit or prohibit funds from such a line of credit to be used at such different channels of commerce.

In certain embodiments, such spending controls dictate whether or not any funds from the approved line of credit may be used at a gaming establishment channel of commerce. For example, based on historical information that funds drawn from a line of credit spent at a first gaming establishment channel of commerce, such as a nightclub or concert venue, have a higher default rate than funds drawn from a line of credit spent at a second gaming establishment channel of commerce, such as gaming establishment golf fees, the system determines to associate the approved line of credit with a spending control corresponding to the first gaming establishment channel of commerce. In this example, the spending control provides that funds from the approved line of credit may not be used at the first gaming establishment channel of commerce (without similarly prohibiting use of funds from the approved line of credit at the second gaming establishment channel of commerce).

In certain embodiments, such spending controls dictate an amount of funds from the approved line of credit that may be used at a gaming establishment channel of commerce. For example, based on historical information that funds drawn from a line of credit spent at a first gaming establishment channel of commerce, such as at a gaming establishment coffee shop, generate more late fees than funds drawn from a line of credit spent at a second gaming establishment channel of commerce, such as gaming establishment spa, the system determines to associate the approved line of credit with a spending control corresponding to a percentage (or total amount) of the funds from the approved line of credit that may be used at the first gaming establishment channel of commerce. In this example, in an attempt to protect gaming establishment patrons and reduce late fees owed on lines of credit, the spending control provides that only a portion of the funds from the approved line of credit may be used at the first gaming establishment channel of commerce (without similarly placing any restrictions on the use of funds from the approved line of credit at the second gaming establishment channel of commerce).

In certain embodiments, the determination to associate one or more spending controls with an approved line of credit is based on one or more inputs from the user. In these embodiments, when applying for the line of credit, the user indicates that they would like one or more spending controls to attach to the line of credit to act as a guard against the user spending too much money in one or more gaming establishment channels of commerce. In certain embodiments, the determination to associate one or more spending controls with an approved line of credit is additionally or alternatively based on one or more inputs from a gaming establishment operator (or an operator of one or more of the channels of commerce within the gaming establishment). In these embodiments, the gaming establishment operator sets one or more spending controls to attach to the line of credit to act as a guard against the user spending too much money in one or more gaming establishment channels of commerce. It should be appreciated that these embodiments employ the spending controls as part of an expanded responsible gaming solution which puts restrictions not only on gaming activities but also on non-gaming activities available at a gaming establishment.

In certain embodiments, the system employs the same spending controls with a user over multiple lines of credit. In certain other embodiments, the system employs different spending controls with a user over multiple lines of credit. That is, the system utilizes historical data regarding the user and past lines of credit in determining one or more aspects of one or more spending controls to associate with an approved line of credit. In these embodiments, depending on how a user activates funds from one or more lines of credit, where the user spends such activated funds, how the user pays back activated funds from one or more lines of credit and/or when the user pays back such activated funds, the system determines one or more aspects of one or more spending controls to employ. For example, if the system determines that a user activates more and more funds from a line of credit in a particular gaming establishment channel of commerce, the system modifies, via increasing or decreasing the spending control (compared to historical spending controls and/or currently employed spending controls), the amount of funds which may be used at that particular gaming establishment channel. In another example, if the system determines, based on repayment behavior and/or the amount of fees a user is having to pay, that the user should be limited from spending funds from a line of credit on certain activities, the system modifies, such as decreases, the spending control (compared to historical spending controls and/or currently employed spending controls), the amount of funds which may be used on such activities. Accordingly, in various embodiments, responsive to an occurrence of a spending control modification event (which may occur based on how a user activates funds from one or more lines of credit, where the user spends such activated funds, how the user pays back activated funds from one or more lines of credit and/or when the user pays back such activated funds), the system modifies one or more aspects of one or more associated spending controls.

If the system determines that no spending controls need to be associated with the approved line of credit, the system issues the line of credit associated with an available amount of funds to be activated. That is, following a determination that no spending controls attach to an approved line of credit, the system enables the user to utilize the requested amount of funds associated with the approved line of credit.

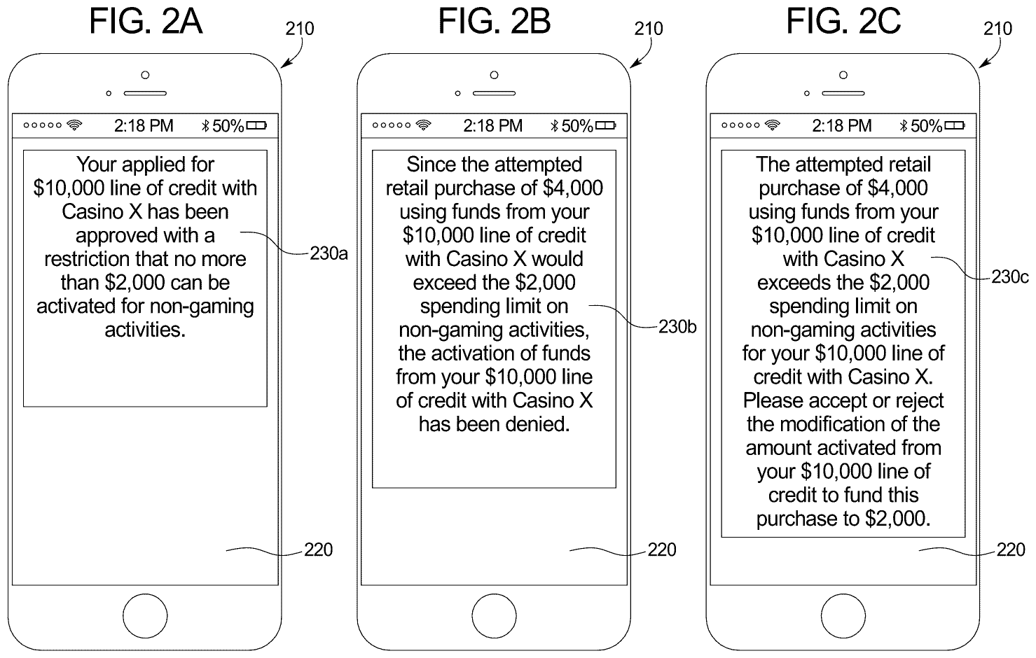

On the other hand, if the system determines that one or more spending controls need to be associated with the approved line of credit, the system causes such spending controls to be associated with the approved line of credit and then issues the line of credit associated with an available amount of funds to be activated subject to the associated spending controls. In other words, following a determination that one or more spending controls attach to an approved line of credit, the system enables the user to utilize, in compliance with such spending controls, the requested amount of funds associated with the approved line of credit and notifies the user of such a determination. For example, as seen in FIG. 2A, following a determination that based on a user's line of credit spending pattern, only a portion of the funds available for a line of credit may be used in a non-gaming channel of commerce, the system approves the line of credit (subject to associated spending controls) and communicates data that results in a mobile device application 220 of a mobile device 210 of the user displaying a message 230a that the applied for a line of credit of $10,000 has been approved with a restriction that no more than $2,000 be used for non-gaming activities.

In certain embodiments, the determination of one or more attributes of the applied for line of credit, such as the determination of whether to approve the applied for line of credit, the determination of an amount of credit to offer the user and/or the determination of any spending control to associate with the line of credit is additionally or alternatively based on data the system analyzes from one or more external data sources. For example, the gaming establishment credit system operates with a gaming establishment credit reporting/credit risk system to determine one or more attributes of the applied for line of credit, such as the determination of whether to approve the applied for line of credit, the determination of an amount of credit to offer the user and/or the determination of any spending control to associate with the line of credit.

In certain embodiments, the determination of one or more attributes of the applied for line of credit, such as the determination of whether to approve the applied for line of credit, the determination of an amount of credit to offer the user and/or the determination of any spending control to associate with the line of credit is additionally or alternatively based on historical line of credit information pertaining to the user, such as the user's past activities regarding paying off outstanding lines of credit.

In certain embodiments, the determination of one or more attributes of the applied for line of credit, such as the determination of whether to approve the applied for line of credit, the determination of an amount of credit to offer the user and/or the determination of any spending control to associate with the line of credit is additionally or alternatively based on gaming information pertaining to the user, such as historical amounts of wagers placed by the user and/or the types of wagers placed (e.g., wagers on games of chance versus wager on outcomes of sporting events). In different embodiments, such gaming information includes gaming information with funds activated from one or more lines of credit and/or gaming information with funds independent of any lines of credit.

In certain embodiments, the determination of one or more attributes of the applied for line of credit, such as the determination of whether to approve the applied for line of credit, the determination of an amount of credit to offer the user and/or the determination of any spending control to associate with the line of credit is additionally or alternatively based on non-gaming information pertaining to the user, such as the user's retail spending data, including, but not limited to, how much the user spent on retail purchases and at which gaming establishment channels of commerce did the user spend on retail purchases. In different embodiments, such non-gaming information includes non-gaming information with funds activated from one or more lines of credit and/or non-gaming information with funds independent of any lines of credit.

In certain embodiments, the determination of one or more attributes of the applied for line of credit, such as the determination of whether to approve the applied for line of credit, the determination of an amount of credit to offer the user and/or the determination of any spending control to associate with the line of credit is additionally or alternatively based on one or more attributes or characteristics of the user, such as a player ranking status of the user in a gaming establishment player tracking system.

In certain embodiments, the determination of one or more attributes of the applied for line of credit, such as the determination of whether to approve the applied for line of credit, the determination of an amount of credit to offer the user and/or the determination of any spending control to associate with the line of credit is additionally or alternatively based on any outstanding lines of credits for the user. In certain embodiments, the determination of one or more attributes of the applied for line of credit, such as the determination of whether to approve the applied for line of credit, the determination of an amount of credit to offer the user and/or the determination of any spending control to associate with the line of credit is additionally or alternatively based on an amount of the requested funds by the user (or an amount of requested funds for multiple users).

Accordingly, rather than offering a line of credit to a user without regarding to the user's past use of funds from lines of credits and/or the user's anticipated use of funds from the applied for line of credit, the system of certain embodiments of the present disclosure utilizes zero, one or more spending controls to enable a relatively more informed decision in offering lines of credit to users. That is, providing gaming establishment credit systems information about prior and/or anticipated use of such funds in one or more different channels of commerce, aids the gaming establishment credit system in offering the user a line of credit, thereby reducing the likelihood that a line of credit is extended to an otherwise unqualified user whom poses a relatively high risk of not paying back the funds activated from the line of credit.

### Accessing Funds from an Issued Line of Credit and Transferring Accessed Funds To/From A Gaming Establishment Device

In various embodiments, following the approval of a line of credit based on or otherwise associated with zero, one or more spending controls, the system enables a user to make one or more inputs to cause a deposit an amount of funds associated with an issued line of credit into a gaming establishment account, such as a cashless wagering account or a gaming establishment retail account. The system further enables the user to make one or more inputs to initiate a transfer of funds from the gaming establishment account to a gaming establishment device, such as to a credit balance of an EGM (wherein upon being cashed out, such funds return to the gaming establishment account and are not automatically used to settle part or all of the amount owed on the line of credit) or to a gaming establishment retail point-of-sale terminal to complete a retail transaction.

In certain embodiments, if a user wants to access the funds associated with a line of credit or marker at a gaming establishment device, such an EGM or a point-of-sale terminal, then following the user establishing the line of credit or marker with a gaming establishment credit system as described above, the user pairs or links their mobile device with the gaming establishment device, wherein this pairing or linkage between the mobile device and the gaming establishment device occurs via one or more applications being run or executed on the mobile device. In certain embodiments, to pair the mobile device with a gaming establishment device, the mobile device application prompts the user to cause the mobile device to engage the gaming establishment device or a component of the gaming establishment device, such as prompting the user to tap the mobile device to a player tracking card reader or other designated location(s) of the gaming establishment device. After such engagement, the mobile device application communicates, via a wireless communication protocol (including, but not limited to: Bluetooth™, Bluetooth™ Low Energy (“BLE”), one or more cellular communication standards (e.g., 3G, 4G, 5G, LTE), one or more Wi-Fi compatible standards, and one or more short range communication protocols (e.g., a near field communication (“NFC”) protocol), applicable data to the gaming establishment device to establish a wireless communication channel between the mobile device and the gaming establishment device.

Following the pairing between the mobile device and the gaming establishment device (or a component of the gaming establishment device, such as a slot machine interface board (“SMIB”) of an EGM or other component of a gaming establishment management system supported by the gaming establishment device), the system enables the user to utilize a mobile device to view information about one or more issued lines of credit (e.g., an available amount of funds associated with the issued line of credit, an amount of funds associated with the issued line of credit previously accessed and/or any spending controls in place) as well as the balance of zero, one or more gaming establishment accounts.

In addition to enabling the user to view, via the mobile device application of the paired mobile device, information about one or more issued lines of credit, the system enables the user to attempt to activate, subject to any associated spending controls, all or part of the available amount of funds associated with the issued line of credit to the gaming establishment device. That is, the system enables the user to attempt to access the issued line of credit from the mobile device application wherein the accessed amount of funds are transferred to a gaming establishment device in a gaming establishment channel of commerce (which, in certain embodiments, includes a first transfer to a gaming establishment account associated with the user following by a second transfer to the gaming establishment device). In these embodiments, interfacing with the mobile device application, the gaming establishment device and/or a component of the gaming establishment device, the system enables the player to make one or more inputs regarding the requested access to the line of credit, such as, but not limited to, one or more inputs to indicate an amount of funds to be accessed from the line of credit, one or more inputs to approve the indicated amount of funds to be accessed from the line of credit, and/or one or more inputs to confirm the accessing of the line of credit.

It should be appreciated that certain jurisdictional regulations and/or gaming establishment policies require the user to approve their transaction to access the funds on their issued line of credit. In one such embodiment, the user acknowledges the approval of accessing the issued line of credit by entering a personal identification number (“PIN”) via the mobile device application, providing a signature and/or presenting a biometric identifier to the mobile device. In another embodiment, the user acknowledges the approval of accessing the issued line of credit by entering a PIN, providing a signature and/or presenting a biometric identifier to the gaming establishment device or a peripheral device associated with the gaming establishment device, such as a display device or input device associated with a SMIB in communication with an EGM.

In these embodiments, following receipt of the user inputted data associated with an amount of funds to be accessed from the issued line of credit and a confirmation from the user that they approve of the transaction and agree to any terms associated with the transaction, the mobile device application, the gaming establishment device and/or a component of the gaming establishment device (e.g., a SMIB of an EGM) communicates one or more messages to the gaming establishment credit system to log the user into the gaming establishment credit system (if necessary) and request an activation of the amount of funds to be accessed from the issued line of credit of the user.

Upon receiving the messages from the mobile device application, the gaming establishment device and/or the component of the gaming establishment device (e.g., a SMIB of an EGM) and verifying the request, the gaming establishment credit system operates with the gaming establishment credit spending control system to determine if any spending controls are associated with the line of credit. That is, prior to approving the activation of an amount of funds drawn from an issued line of credit, the gaming establishment credit system determines, such as by interfacing with the gaming establishment credit spending control system or retrieving information regarding the line of credit from one or more credit databases, whether the requested activation of funds needs to comply with any spending controls.

If the gaming establishment credit system determines at least one spending control is associated with the line of credit, the gaming establishment credit system determines if the requested activation of funds complies with the associated spending controls. In other words, before releasing any funds from a line of credit, the system first needs to determine whether any restrictions are in place regarding the use of such funds. For example, if the gaming establishment credit system previously issued a line of credit for $10,000 for a user, but the line of credit is associated with a spending control that no more than $2,000 may be used to make retail purchases at the gaming establishment, the system determines the channel of commerce associated with the requested fund activation as well as the amount of the requested fund activation.

In certain embodiments, if the gaming establishment credit system determines that the requested activation of funds does not comply with the associated spending controls, the gaming establishment credit system does not authorize the activation of an amount of funds from the issued line of credit and communicates a denial to the mobile device application, the gaming establishment device and/or a component of the gaming establishment device. For example, if the gaming establishment credit system previously issued a line of credit for $10,000 for a user and the line of credit is associated with a spending control that no more than $2,000 may be used to make retail purchases at the gaming establishment, upon the user attempting to withdraw $4,000 from the line of credit to make a retail purchase, the point-of-sale terminal where the retail transaction is attempted to be made notifies the gaming establishment credit system of the channel of commerce of the attempted retail transaction. In this example, based on the request activation of funds from the line of credit being for a retail purchase and further based on the attempted activation of funds from the line of credit being for more than $2,000, the gaming establishment credit system declines the requested activation of funds.

Following the denial of the activation of funds from the line of credit, one or more display devices associated with the mobile device, the gaming establishment device and/or a component of the gaming establishment device display a denial of line of credit activation to the user. For example, as seen in FIG. 2B, following the denial of the requested activation of $4,000 from the line of credit to complete a retail purchase at a point-of-sale terminal, a mobile device application 220 of a mobile device 210 (which the user employed in the attempt to facilitate the purchase at the point-of-sale terminal) displays a message 230b to a user that since the attempted retail purchase price exceeds the limit on retail purchases associated with the $10,000 line of credit, the attempted retail transaction using funds from the line of credit has been denied.

In certain embodiments, if the gaming establishment credit system determines that the requested activation of funds does not comply with the associated spending controls, the gaming establishment credit system attempts to modify the requested activation of an amount of funds from the issued line of credit. In one such embodiment, the gaming establishment credit system communicates a modification notification to the mobile device application, the gaming establishment device and/or a component of the gaming establishment device and requests the user to accept or decline the attempted modification of the requested activation of an amount of funds from the issued line of credit. For example, if the gaming establishment credit system previously issued a line of credit for $10,000 for a user and the line of credit is associated with a spending control that no more than $2,000 may be used to make retail purchases at the gaming establishment, upon the user attempting to withdraw $4,000 from the line of credit to make a retail purchase, the point-of-sale terminal where the retail transaction is attempted to be made notifies the gaming establishment credit system of the channel of commerce of the attempted retail transaction. In this example, based on the request activation of funds from the line of credit being for a retail purchase and further based on the attempted activation of funds from the line of credit being for more than $2,000, the gaming establishment credit system requests the user to accept or reject a modified amount of $2,000 activated from the line of credit. For example, as seen in FIG. 2C, following a determination that the requested activation of $4,000 from the line of credit to complete a retail purchase at a point-of-sale terminal would violate a spending control on the line of credit, a mobile device application 220 of a mobile device 210 (which the user employed in the attempt to facilitate the purchase at the point-of-sale terminal) displays a message 230c to a user requesting the user to accept a modification of the amount borrowed against the line of credit to $2,000 to ensure that the attempted retail purchase price complies with the limit on retail purchases associated with the $10,000 line of credit.

In certain embodiments, if the gaming establishment credit system determines that the requested activation of funds complies with the associated spending controls (or that the modified requested activation of funds complies with the associated spending controls), the gaming establishment credit system proceeds with operating with the gaming establishment fund management system or a component of the gaming establishment fund management system, such as a gaming establishment cashless wagering system or a gaming establishment retail system, to log the user into a gaming establishment account associated with the user (if necessary) and potentially transfer the amount of funds to be accessed from the issued line of credit of the user to the gaming establishment account associated with the user (to then be transferred to the gaming establishment device as described below). In these embodiments, the gaming establishment credit system updates the amount available of the issued line of credit and the channel of commerce at which such funds were used. The gaming establishment credit system also communicates an authorization of the requested amount of funds to the gaming establishment fund management system. Upon receiving the authorization, the gaming establishment fund management system updates a balance of a gaming establishment account by the requested amount of funds activated from the line of credit and proceeds with transferring the amount of funds from the line of credit to the gaming establishment device. In certain embodiments, in association with the transfer of an amount of funds associated with activated line of credit, the system communicates a transfer of funds confirmation, wherein one or more display devices associated with the mobile device, the gaming establishment device and/or a component of the gaming establishment device display a confirmation of the transfer of the amount of funds from the line of credit to the gaming establishment account.

In certain embodiments, following the completion of the transfer of an amount of funds associated with the line of credit to the gaming establishment account, the system facilitates a transfer of an amount of funds from the gaming establishment account to a gaming establishment device, such as an EGM or point-of-sale terminal. In these embodiments, the gaming establishment fund management system (or a component of the gaming establishment fund management system, such as the cashless wagering system) updates the gaming establishment account associated with the user and communicates an authorization to the gaming establishment device. For example, when funds withdrawn from a line of credit are being transferred from a cashless wagering account to an EGM, the cashless wagering system reduces a balance of the cashless wagering account by the reduced amount of funds. The EGM proceeds with updating a credit balance of the EGM to account for the amount of funds. In another example, when funds withdrawn from a line of credit are being transferred from a gaming establishment retail account to a retail point-of-sale terminal, following a confirmation by the retail point-of-sale system that the gaming establishment retail account has adequate funds for the intended purchase, the retail point-of-sale system authorizes the sale of the goods and/or services and the gaming establishment retail wallet system transfers an amount of funds corresponding to the price of the purchased goods and/or services from the gaming establishment retail account maintained for the retail patron to one or more accounts associated with or otherwise maintained for the retailer. On the other hand, if the gaming establishment retail wallet system indicates that the gaming establishment retail account lacks adequate funds for the purchase, the retail point-of-sale system denies this sale transaction of the goods and/or services using the gaming establishment retail account.

In certain embodiments, if the gaming establishment credit system determines that the requested activation of funds complies with the associated spending controls (or that the modified requested activation of funds complies with the associated spending controls), the gaming establishment credit system proceeds with transferring the funds from the line of credit to the gaming establishment device, such as to the credit balance of an EGM or to a point-of-sale terminal of a gaming establishment retail system. In these embodiments, the gaming establishment credit system updates the amount available of the issued line of credit as well as the channel of commerce at which such funds were used.

It should be appreciated that while described as utilizing a mobile device running a mobile device application to access funds associated with different gaming establishment accounts, to apply for one or more lines of credit subject to any spending controls and/or to access funds associated with one or more lines of credit subject to any spending controls, in various embodiments, the system utilizes any suitable interface, such as an interface of the gaming establishment device, an interface of a service window displayed by a gaming establishment device (e.g., a remote host controlled service window displayed by an EGM), and/or an interface of a component of a gaming establishment patron management system, such as a player tracking unit, to enable the user at the gaming establishment device to access funds associated with different gaming establishment accounts, to apply for one or more lines of credit subject to any spending controls and/or to access funds associated with one or more lines of credit subject to any spending controls.

It should be further appreciated that in certain embodiments wherein an amount of funds from a line of credit are activated, subject to zero, one or more spending controls, and transferred to an EGM (or other gaming establishment device), following the use of zero, part or all of the transferred amount of funds at an EGM and upon receiving a “cash out” input from the player, part or all of the credit balance of the EGM is transferred to the gaming establishment account, such as the cashless wagering account independent of any attempt to repay the amount of funds outstanding on any activated lines of credit. In these embodiments, unlike prior systems which required that any amount cashed out from an EGM is automatically applied to repay the amount of funds outstanding on any activated lines of credit, the system does not mandate that any amount cashed out from an EGM is automatically applied to repay the amount of funds outstanding on any activated lines of credit. Rather, the system continues to maintain the outstanding line of credit balance prior to and after an amount of funds are cashed out from an EGM and enables such cashed out funds to flow to a gaming establishment account, such as a cashless wagering account, thereby reducing user tension by not having to continually activate the line of credit at each EGM played. In other words, to facilitate ease of line of credit fund movement from one EGM to another EGM, the gaming establishment fund management system tracks such line of credit funds as a separate balance eliminating the need to repeatedly reactivate a line of credit after each cash out event (thus saving the user time).

In certain embodiments wherein an amount of funds from a line of credit are activated, subject to zero, one or more spending controls, and transferred to an EGM (or other gaming establishment device), following one or more inputs to cash out a credit balance of an EGM to a gaming establishment account (which may be made in association with the EGM, in association with a component of the EGM or in association with a mobile device application of a mobile device paired to the EGM), the EGM (or a component of the EGM, such as the SMIB) operates with the gaming establishment fund management system (or a component of the gaming establishment fund management system, such as the cashless wagering system), to transfer the amount of funds of the credit balance of the EGM to the gaming establishment account, such as the cashless wagering account associated with the player.

In certain other embodiments wherein an amount of funds from a line of credit are activated, subject to zero, one or more spending controls, and transferred to an EGM (or other gaming establishment device), the system determines to facilitate the transfer of funds from the EGM to a gaming establishment account, such as the cashless wagering account, independent of any input by the player. In one such embodiment, if the system determines that no activity has occurred for a designated amount of time, as a precautionary measure, the system transfers the credit balance of the EGM from the EGM to the gaming establishment account used to transfer funds to the EGM. In another embodiment, if the system determines that another player is attempting to log onto the EGM, as a precautionary measure, the system transfers the credit balance of the EGM from the EGM to the gaming establishment account used to transfer funds to the EGM. Such transfers of the credit balance to the gaming establishment account is associated with a termination of the player's current gaming session.

In these embodiments, after a determination to transfer the credit balance of the EGM from the EGM to a gaming establishment, the EGM proceeds with operating with the gaming establishment fund management system (or a component of the gaming establishment fund management system, such as the cashless wagering system) to log the player into a gaming establishment account, such as a cashless wagering account associated with the player (or confirm that the player remains logged into the gaming establishment account) and request the determined amount of funds to be transferred from the EGM to the gaming establishment account. Following such a request, the EGM proceeds with updating a credit balance of the EGM to account for the determined amount of funds transferred from the EGM to the gaming establishment account. The gaming establishment system (or the component of the gaming establishment fund management system, such as the cashless wagering system) additionally updates the gaming establishment account associated with the player (e.g., the cashless wagering system adds the determined amount of funds to the cashless wagering account) and communicates a confirmation to the EGM. The EGM further proceeds with displaying a transfer of funds confirmation (and additionally or alternatively communicating a transfer of funds confirmation to the mobile device), wherein the EGM (and/or the mobile device application) displays a confirmation of the transfer of the amount of funds and/or the updated credit balance of the EGM. Such a transferred amount of funds is available in the gaming establishment account to be transferred to another gaming establishment device (such as another EGM or a gaming table component) or another gaming establishment account, such as to a gaming establishment retail account.

### Repaying of Activated Line of Credit

In various embodiments wherein a line of credit is opened and/or usable subject to zero, one or more spending controls, in addition to funding a gaming establishment account with an amount of funds associated with an issued line of credit and enabling such funds to be cashed out from a credit balance of a gaming device to a gaming establishment account, the system monitors for an occurrence of a line of credit repayment event. In these embodiments, upon a line of credit repayment event, the system attempts to repay part or all of the outstanding line of credit balance wherein repayment is subject to zero, one more spending controls.

Specifically, upon an occurrence of a line of credit repayment event, the gaming establishment fund management system (or a component of the gaming establishment fund management system) communicates one or more messages to the gaming establishment credit system to log the user into the gaming establishment credit system (if necessary) and attempts to pay back an amount of funds accessed from the issued line of credit of the user. Upon receiving the messages and verifying the request, the gaming establishment credit system operates with the gaming establishment credit spending control system to determine if any spending controls are associated with the line of credit. That is, prior to approving the paying back of an amount of funds withdrawn from an issued line of credit, the gaming establishment credit system determines, such as by interfacing with the gaming establishment credit spending control system or retrieving information regarding the line of credit from one or more credit databases, whether the requested repayment of funds needs to comply with any spending controls.

If the gaming establishment credit system determines at least one spending control is associated with the line of credit, the gaming establishment credit system determines if the requested repayment of funds complies with the associated spending controls. In other words, due to certain jurisdictional requirements, such as those that prevent funds from one line of credit being used to pay back another line of credit, before paying back any funds from a line of credit, the system first needs to determine whether any restrictions are in place regarding the repayment of such funds.

In certain embodiments, if the gaming establishment credit system determines that the requested repayment of funds does not comply with the associated spending controls, the gaming establishment credit system does not authorize the repayment of an amount of funds from the issued line of credit and communicates a denial to the mobile device application, the gaming establishment device and/or a component of the gaming establishment device attempted to pay back the line of credit.

On the other hand, if the gaming establishment credit system determines that the requested repayment of funds complies with the associated spending controls, to complete a transfer of an amount of funds associated with a line of credit from a gaming establishment account, the gaming establishment fund management system determines whether to authorize the transfer of the determined amount of funds to pay off part or all of the issued line of credit. In these embodiments, if the gaming establishment fund management system determines not to authorize the transfer of the determined amount of funds to pay off the issued line of credit (e.g., the gaming establishment account balance lacks the funds to pay off part or all of the issue line of credit), the gaming establishment fund management system communicates a denial to the gaming establishment credit system. In certain embodiments, following the denial, one or more display devices display a denial of line of credit payoff to the user.

On the other hand, if the gaming establishment fund management system determines to authorize the transfer of the determined amount of funds to pay off part or all the issued line of credit (e.g., the gaming establishment account balance has adequate funds to pay off part or all of the issue line of credit and the repayment complies with any spending controls), the gaming establishment fund management system updates the outstanding line of credit balance (to reflect a paying off of part or all of the issued line of credit), updates the balance of the gaming establishment account (to reflect the transfer of the funds away from the gaming establishment account) and communicates an authorization of the transfer to the gaming establishment credit system. Upon receiving the authorization, the gaming establishment credit system updates the outstanding line of credit.

In certain embodiments, a line of credit repayment event occurs responsive to one or more inputs made by the user indicating a repayment of part or all of an outstanding line of credit. In these embodiments, the user may make such inputs via any suitable interface at any suitable device such as via a kiosk, via a mobile device application, and/or via a web interface, wherein such inputs trigger the line of credit repayment event and the gaming establishment fund management system operating with the gaming establishment credit system to repay part or all of one or more outstanding lines of credit. In certain embodiments, a line of credit repayment event occurs responsive to one or more inputs made by an operator of the system indicating a request for a repayment of part or all of an outstanding line of credit. In these embodiments, the operator may make such inputs via any suitable interface at any suitable device such as via a device at a gaming establishment cage, via an operator work station and/or via a web interface, wherein such inputs trigger the line of credit repayment event and the gaming establishment fund management system operating with the gaming establishment credit system to repay part or all of one or more outstanding lines of credit.

In certain embodiments, a line of credit repayment event occurs responsive to one or more events occurring in association with the gaming establishment fund management system. In these embodiments, the gaming establishment fund management system (or a component of the gaming establishment fund management system, such as the cashless wagering system) determines that a line of credit repayment event occurs at a designated interval, such as every hour, every 24 hours, every week, when the gaming establishment's “end of day” occurs or a date/time when repayment of the line of credit is required, wherein such events trigger the line of credit repayment event and the gaming establishment fund management system operating with the gaming establishment credit system to repay part or all of one or more outstanding lines of credit. In certain embodiments, a line of credit repayment event occurs responsive to one or more notifications being received by the gaming establishment fund management system. In these embodiments, the gaming establishment fund management system (or a component of the gaming establishment fund management system, such as the cashless wagering system) determines that a line of credit repayment event occurs upon receiving a notification associated with a user having an outstanding line of credit, such as upon a player with a positive outstanding line of credit balance checking out of their hotel room or upon a player with a positive outstanding line of credit balance ending their trip to the gaming establishment, wherein such notifications trigger the gaming establishment fund management system operating with the gaming establishment credit system to repay part or all of one or more outstanding lines of credit.

In certain embodiments, a line of credit repayment event occurs responsive to one or more events occurring in association with the gaming establishment credit system. In these embodiments, the gaming establishment credit system determines that a line of credit repayment event occurs at a designated interval, such as every hour, every 24 hours, every week, when the gaming establishment's “end of day” occurs or a date/time when repayment of the line of credit is required, wherein such events trigger the line of credit repayment event and the gaming establishment credit system attempting to operate with the gaming establishment fund management system to repay part or all of one or more outstanding lines of credit. In certain embodiments, a line of credit repayment event occurs responsive to one or more notifications being received by the gaming establishment credit system. In these embodiments, the gaming establishment credit system determines that a line of credit repayment event occurs upon the gaming establishment credit system receiving a notification associated with a user having an outstanding line of credit, such as upon a player with a positive outstanding line of credit balance checking out of their hotel room or upon a player with a positive outstanding line of credit balance ending their trip to the gaming establishment, wherein such notifications trigger the gaming establishment credit system attempting to operate with the gaming establishment fund management system to repay part or all of one or more outstanding lines of credit.

In certain embodiments, a line of credit repayment event occurs responsive to a deposit of an amount of funds to a gaming establishment account, such as a cashless wagering account. In certain such embodiments, the system determines if a line of credit repayment event occurs upon a deposit of an amount of funds to a gaming establishment account based on the device utilized to make such a deposit. That is, the system can determine what type of device is performing the deposit and whether the deposit with that type of device warrants an occurrence of a line of credit repayment event. For example, if an amount of funds is deposited to a gaming establishment account from an EGM, the system may assume that this deposit action is the result of a cash-out and this can then trigger (possibly with the player's prior authorization) an attempt to repay some or all of the outstanding balance of the line of credit from the amount transferred from the EGM to the gaming establishment account. It should be appreciated that since, as described below, an amount may be deposited into a gaming establishment as a player directed non-cash out action via an interface of an EGM, in certain embodiments, the system determines if a line of credit repayment event occurs upon a deposit of an amount of funds to a gaming establishment account based on the device utilized to make such a deposit and one or more actions undertaken at that device.

### Additional Sourcing of Funds Transferred to Gaming Establishment Fund Management Account

In various embodiments, in addition to funding a gaming establishment account with an amount of funds associated with an issued line of credit (subject to zero, one or more spending controls), the system enables the gaming establishment account to be funded from one or more additional sources.

In certain embodiments, the gaming establishment fund management account is associated with one or more external accounts, such as one or more credit card accounts, one or more debit card accounts and/or one or more third-party maintained accounts (e.g., one or more PayPal® accounts or Venmo® accounts). In certain embodiments, the gaming establishment fund management account is associated with a gaming establishment or a group of gaming establishments, wherein the user establishes a gaming establishment fund management account by a deposit of funds (such as at a kiosk) to be subsequently utilized in association with the mobile device application. In other embodiments, the gaming establishment fund management account is funded via a mobile device electronic fund transfer, such using Apple Pay™ or Android Pay™. It should be appreciated that in different embodiments, the system utilizes a mobile device running a mobile device application, a kiosk, an EGM, a gaming table component, a service window displayed by a gaming device (e.g., a remote host controlled service window displayed by an EGM) and/or a gaming establishment interface to facilitate the transfer of funds from a third-party account.

In certain embodiments, the system enables funds to be deposited in a gaming establishment fund management account via a gaming device, such as an EGM. In certain embodiments, the system enables a user that has an amount of cash to utilize a gaming device to convert the cash to an amount deposited into a gaming establishment fund management account (which may be subsequently transferred utilizing a mobile device application). In other embodiments, the system enables funds to be deposited in a gaming establishment fund management account via a gaming device that accepts printed ticket vouchers. In these embodiments, the system enables a user that has one or more printed ticket vouchers to utilize a gaming device to convert the printed ticket voucher to an amount deposited into a gaming establishment fund management account (which may be subsequently transferred utilizing a mobile device application).

In certain embodiments, the system enables funds to be deposited in a gaming establishment fund management account via a gaming establishment interface, such as a gaming establishment cage or desk. In certain embodiments, the system enables a user that has an amount of cash to utilize a gaming establishment interface, such as a gaming establishment cage or desk to convert the cash to an amount deposited into a gaming establishment fund management account (which may be subsequently transferred utilizing a mobile device application). In other embodiments, the system enables funds to be deposited in a gaming establishment fund management account via a gaming establishment interface that accepts printed ticket vouchers. In these embodiments, the system enables a user that has one or more printed ticket vouchers to utilize a gaming establishment interface to convert the printed ticket voucher to an amount deposited into a gaming establishment fund management account (which may be subsequently transferred utilizing a mobile device application).

In certain embodiments, the system enables funds to be deposited in a gaming establishment fund management account via a kiosk that accepts money. In certain embodiments, the system enables a user that has an amount of cash to utilize a kiosk to convert the cash to an amount deposited into a gaming establishment fund management account (which may be subsequently transferred to a gaming device utilizing a mobile device application). In other embodiments, the system enables funds to be deposited in a gaming establishment fund management account via a kiosk that accepts printed ticket vouchers. In certain embodiments, the system enables a user that has one or more printed ticket vouchers to utilize a kiosk to convert the printed ticket voucher to an amount deposited into a gaming establishment fund management account (which may be subsequently transferred to a gaming device utilizing a mobile device application).

In certain embodiments, the gaming establishment fund management account is associated with funds associated with one or more virtual ticket vouchers. In certain embodiments, the system enables a user associated with an amount of virtual ticket vouchers to utilize a gaming device (e.g., an EGM, a component of an EGM) a mobile device running a mobile device application, a kiosk and/or a gaming establishment interface to convert the virtual ticket vouchers to an amount deposited into a gaming establishment fund management account.

In certain embodiments, the system enables a user to fund the gaming establishment fund management account independent of the mobile device and independent of the mobile device application. In certain other embodiments, the system enables a user to utilize a mobile device running a mobile device application to fund the gaming establishment fund management account. More specifically and utilizing the example of a kiosk, in one embodiment, to utilize a mobile device and a kiosk to facilitate the funding of a gaming establishment fund management account, the user wirelessly pairs or otherwise connects a mobile device with a kiosk. In one example embodiment, the user moves the mobile device into the range of a wireless receiver of the kiosk. The kiosk and the launched or activated mobile device application of the mobile device negotiate a secure, authenticated connection with the proper functionality, versions and security settings. It should be appreciated that the kiosk wirelessly connects with the mobile device running the mobile device application in the same or similar fashion to how a mobile device is paired or connected with a gaming device of the present disclosure.

After connecting the mobile device to the kiosk, the kiosk prompts the user to deposit an amount of funds into the kiosk. In one such embodiment, the kiosk prompts the user to insert one or more bills into a bill acceptor of the kiosk. In another such embodiment, the kiosk additionally or alternatively prompts the user to deposit a physical ticket voucher (associated with an amount of funds) into the kiosk. In another such embodiment, the kiosk additionally or alternatively prompts the user to deposit a card associated with an external account, such as a credit card or debit card into the kiosk. In another such embodiment, the kiosk additionally or alternatively prompts the user to enter information associated with an external account, such as a credit card account, a PayPal® account, a Venmo® account, or a debit card account into the kiosk. In another such embodiment, the kiosk additionally or alternatively prompts the user to deposit an amount of funds into the kiosk using a mobile device electronic fund transfer, such using Apple Pay™ or Android Pay™.

In one embodiment, after a first amount of funds is accepted, such as after a first bill or unit of currency is accepted, by the kiosk, the kiosk and/or the mobile device application enable the user to transfer the deposited amount of funds (e.g., a “Load Phone Now” button) or continue to deposit additional amounts of funds with the kiosk. In another embodiment, for each amount of funds accepted by the kiosk, such as for each bill or unit of currency accepted by the kiosk, a virtual ticket voucher is created and deposited in the gaming establishment fund management account.

In certain embodiments, upon receiving an amount of funds from the user and the user indicating to transfer the deposited amount of funds in association with the mobile device application, the kiosk communicates with one or more servers to transfer an amount of money to a gaming establishment fund management account (to be drawn upon from the mobile device application of the present disclosure). In another such embodiment, upon receiving an amount of funds from the user and the user indicating to transfer the deposited amount of funds in association with an account or balance associated with the mobile device application, the kiosk communicates with one or more servers, such as a virtual ticket voucher server, to create a virtual ticket voucher associated with the amount of received currency. The system of the present disclosure transfers the created virtual ticket voucher to the gaming establishment fund management account.

It should be appreciated that the electronic fund data transfers of the present disclosure may occur in addition to or as an alternative from cash-based fund transfers and/or ticket voucher-based fund transfers. In one such embodiment, an amount of funds transferred to a gaming establishment device (e.g., an EGM or a retail point-of-sale terminal) is funded via any of an electronic fund transfer, a cash-based fund transfer or a ticket voucher-based fund transfer. In another embodiment, an amount of funds transferred from a gaming establishment device (e.g., an EGM or a gaming table component) is cashed out via any of an electronic fund transfer, a cash-based fund transfer or a ticket voucher-based fund transfer. In another embodiment, an amount of funds transferred to a gaming establishment device (e.g., an EGM or a retail point-of-sale terminal) is funded via an electronic fund transfer or a cash-based fund transfer (but is not funded via any ticket voucher-based fund transfer). In another embodiment, an amount of funds transferred from a gaming establishment device (e.g., an EGM or a gaming table component) is cashed out via an electronic fund transfer or a cash-based fund transfer (but is not cashed out via any ticket voucher-based fund transfer). In another embodiment, an amount of funds transferred to a gaming establishment device (e.g., an EGM or a retail point-of-sale terminal) is funded via an electronic fund transfer or a ticket voucher-based fund transfer (but is not funded via any cash-based fund transfer). In another embodiment, an amount of funds transferred from a gaming establishment device (e.g., an EGM or a gaming table component) is cashed out via an electronic fund transfer or a ticket voucher-based fund transfer (but is not cashed out via any cash-based fund transfer). In another embodiment, an amount of funds transferred to a gaming establishment device (e.g., an EGM or a retail point-of-sale terminal) is funded via an electronic fund transfer (but is not funded via a cash-based fund transfer nor a ticket voucher-based fund transfer). In another embodiment, an amount of funds transferred from a gaming establishment device (e.g., an EGM or a gaming table component) is cashed out via an electronic fund transfer (but is not cashed out via a cash-based fund transfer nor a ticket voucher-based fund transfer).

It should be further appreciated that any functionality or process of the present disclosure may be implemented via one or more servers, one or more gaming establishment devices (e.g., an EGM or a retail point-of-sale terminal), one or more components of a gaming establishment device, one or more gaming establishment components (such as a component of a gaming establishment management system (e.g., a player tracking unit) supported by or otherwise located inside the gaming establishment device), or a mobile device application. For example, while certain data or information of the present disclosure is explained as being communicated from a gaming establishment device (e.g., an EGM or a retail point-of-sale terminal), a component of a gaming establishment device, or a gaming establishment component to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a gaming establishment device (e.g., an EGM or a retail point-of-sale terminal) or a component of a gaming establishment device, such functions, features or processes may alternatively be performed by one or more servers, or one or more mobile device applications, or one or more gaming establishment components (such as a component of a gaming establishment management system (e.g., a player tracking unit) supported by or otherwise located inside the gaming establishment device), (ii) while certain functions, features or processes are described herein as being performed by one or more mobile device applications, such functions, features or processes may alternatively be performed by one or more servers, one or more gaming establishment devices (e.g., an EGM or a retail point-of-sale terminal), one or more components of a gaming establishment device or one or more gaming establishment components, (iii) while certain functions, features or processes are described herein as being performed by one or more servers, such functions, features or processes may alternatively be performed by one or more gaming establishment devices (e.g., an EGM or a retail point-of-sale terminal), one or more components of a gaming establishment device, one or more mobile device applications, or one or more gaming establishment components, and (iv) while certain functions, features or processes are described herein as being performed by one or more gaming establishment components (such as a component of a gaming establishment management system (e.g., a player tracking unit) supported by or otherwise located inside the gaming establishment device), such functions, features or processes may alternatively be performed by one or more gaming establishment devices, one or more components of a gaming establishment device, or one or more mobile device applications, or one or more servers.

### EGM Components

In certain embodiments, the above-described embodiments of the present disclosure may be implemented in accordance with or in conjunction with an EGM.

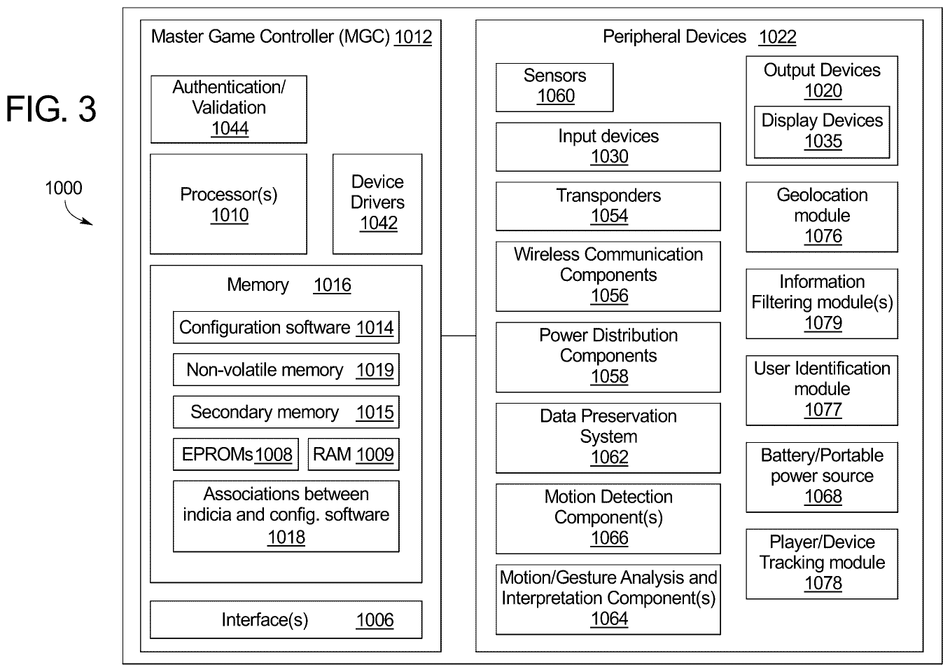

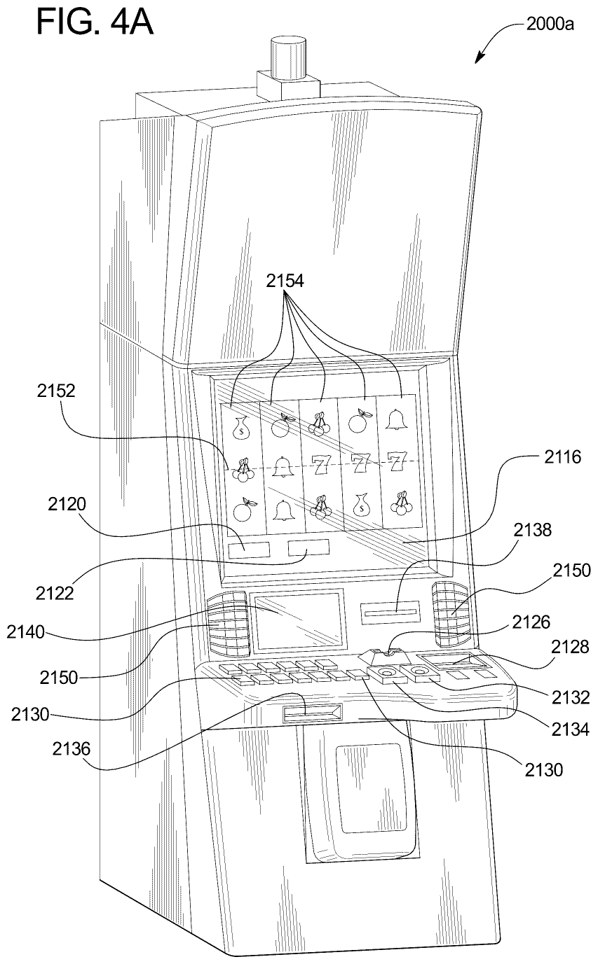

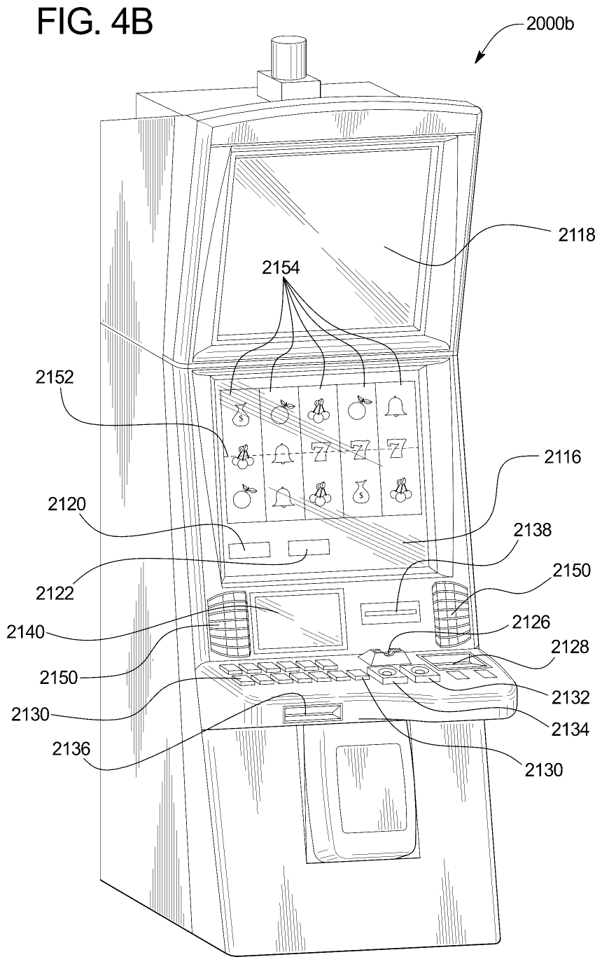

FIG. 3 is a block diagram of an example EGM 1000 and FIGS. 4A and 4B include two different example EGMs 2000a and 2000b. The EGMs 1000, 2000a, and 2000b are merely example EGMs, and different EGMs may be implemented using different combinations of the components shown in the EGMs 1000, 2000a, and 2000b.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM. In certain embodiments, the at least one memory device 1016 resides within the housing of the EGM (described below), while in other embodiments at least one component of the at least one memory device 1016 resides outside of the housing of the EGM.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 4A includes a central display device 2116, a player tracking display 2140, a credit display 2120, and a bet display 2122. The example EGM 2000b illustrated in FIG. 4B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 4A and 4B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 4A and 4B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 4A and 4B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 4A and 4B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 4A and 4B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 4A and 4B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 4A and 4B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 1000 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 4A and 4B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 4A and 4B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all EGMs, and these example EGMs may not include one or more elements that are included in other EGMs. For example, certain EGMs include a coin acceptor while others do not.

### Differentiating Certain Gaming Devices from General Purpose Computing Devices

It should be appreciated that certain of the gaming devices (e.g., EGMs and/or gaming table components) include certain components and/or are configured to operate in certain manners that differentiate these systems from general purpose computing devices (i.e., certain personal devices such as desktop computers and laptop computers).

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A gaming establishment line of credit default reduction system comprising:
a network interface;
a processor operating independent from each of any gaming establishment credit system, any gaming establishment fund management system and any processor of any gaming establishment device; and
a memory device that stores a plurality of instructions that, when executed by the processor following an issuance of a gaming establishment line of credit via a gaming establishment credit system, responsive to a request to activate a first amount of funds from the gaming establishment line of credit, and responsive to a determination, by the gaming establishment credit system, that an activation of the first amount of funds from the gaming establishment line of credit would not cause the gaming establishment line of credit to exceed a maximum amount of activated funds associated with the gaming establishment line of credit, cause the processor to:
determine, based on data received via the network interface and from the gaming establishment credit system, if any spending controls are associated with the gaming establishment line of credit, and
responsive to the determination being that a spending control is associated with the gaming establishment line of credit and without automatically activating the first amount of funds from the gaming establishment line of credit:
determine if the requested activation of the first amount of funds from the gaming establishment line of credit complies with the spending control associated with the gaming establishment line of credit,
responsive to the determination being that the requested activation of the first amount of funds from the gaming establishment line of credit complies with the spending control associated with the gaming establishment line of credit, communicate, via the network interface and to the gaming establishment credit system, data that results in the gaming establishment credit system activating the first amount of funds from the gaming establishment line of credit, and
responsive to the determination being that the requested activation of the first amount of funds from the gaming establishment line of credit fails to comply with the spending control associated with the gaming establishment line of credit, reduce a risk of default associated with the gaming establishment line of credit by communicating, via the network interface and to the gaming establishment credit system, data that results in the gaming establishment credit system not activating the first amount of funds from the gaming establishment line of credit.

2. The gaming establishment line of credit default reduction system of claim 1, wherein the request to activate the first amount of funds from the gaming establishment line of credit occurs in association with a gaming establishment device.

3. The gaming establishment line of credit default reduction system of claim 2, wherein the requested activation of the first amount of funds from the gaming establishment line of credit complies with the spending control associated with the gaming establishment line of credit based on a gaming establishment channel of commerce of the gaming establishment device.

4. The gaming establishment line of credit default reduction system of claim 3, wherein the requested activation of the first amount of funds from the gaming establishment line of credit complies with the spending control associated with the gaming establishment line of credit based on a comparison of the first amount of funds to a second amount of funds associated with the gaming establishment channel of commerce of the gaming establishment device.

5. The gaming establishment line of credit default reduction system of claim 1, wherein the memory device stores a plurality of further instructions that, when executed by the processor responsive to the requested activation of the first amount of funds from the gaming establishment line of credit not complying with the spending control associated with the gaming establishment line of credit, cause the processor to communicate, via the network interface and to the gaming establishment credit system, data that results in an offer, by the gaming establishment credit system, of a second, different amount of funds from the gaming establishment line of credit, the second, different amount of funds from the gaming establishment line of credit complying with the spending control associated with the gaming establishment line of credit.

6. The gaming establishment line of credit default reduction system of claim 5, wherein an acceptance of the offer of the second, different amount of funds from the gaming establishment line of credit results in an activation of the second, different amount of funds from the gaming establishment line of credit.

7. The gaming establishment line of credit default reduction system of claim 1, wherein activations of different amounts of funds from the gaming establishment line of credit are associated with different spending controls.

8. The gaming establishment line of credit default reduction system of claim 1, wherein the memory device stores a plurality of further instructions that, when executed by the processor responsive to the determination being that the requested activation of the first amount of funds from the gaming establishment line of credit complies with the spending control associated with the gaming establishment line of credit, cause the processor to cause a serial communication, in accordance with a slot accounting system protocol, of data associated with the activation of the first amount of funds from the gaming establishment line of credit to an electronic gaming machine.

9. The gaming establishment line of credit default reduction system of claim 1, wherein the memory device stores a plurality of further instructions that, when executed by the processor responsive to the determination being that the requested activation of the first amount of funds from the gaming establishment line of credit complies with the spending control associated with the gaming establishment line of credit, cause the processor to cause a serial communication, in accordance with a slot accounting system protocol, of data associated with the activation of the first amount of funds from the gaming establishment line of credit to a slot machine interface board associated with an electronic gaming machine.

10. A gaming establishment credit system comprising:
a network interface;
a processor operating independently from any gaming establishment credit spending control system, any gaming establishment fund management system and any processor of any gaming establishment device; and
a memory device that stores a plurality of instructions that, when executed by the processor responsive to a request to establish a gaming establishment line of credit, cause the processor to:
receive, via the network interface, data associated with any spending controls associated with the requested establishment of the gaming establishment line of credit,
responsive to the received data indicating a spending control is associated with the requested establishment of the gaming establishment line of credit, display, by a display device, a notification associated with an enabled activation, from the gaming establishment line of credit, of a first amount of funds within a first type of gaming establishment channel of commerce, and a second, different amount of funds within a second, different type of gaming establishment channel of commerce, and
responsive to the received data indicating that no spending control is associated with the requested establishment of the gaming establishment line of credit, display, by the display device, a notification associated with an enabled activation, from the gaming establishment line of credit, of the first amount of funds within the first type of gaming establishment channel of commerce, and the first amount of funds within the second, different type of gaming establishment channel of commerce.

11. The gaming establishment credit system of claim 10, wherein the data associated with any spending controls associated with the requested establishment of the gaming establishment line of credit is received from a gaming establishment credit spending control system.

12. A method of operating a gaming establishment line of credit default reduction system, the method comprising:
following an issuance, via a gaming establishment credit system, of a gaming establishment line of credit, responsive to a request to activate a first amount of funds from the gaming establishment line of credit and following a determination, by the gaming establishment credit system, that an activation of the first amount of funds from the gaming establishment line of credit would not cause the gaming establishment line of credit to exceed a maximum amount of activated funds associated with the gaming establishment line of credit:
determining, by a processor and based on data received, via a network interface and from the gaming establishment credit system, if any spending controls are associated with the gaming establishment line of credit, the processor operating independently from each of the gaming establishment credit system, any gaming establishment fund management system and any processor of any gaming establishment device, and
responsive to the determination being that a spending control is associated with the gaming establishment line of credit, without automatically activating the first amount of funds from the gaming establishment line of credit:
determining, by the processor, if the requested activation of the first amount of funds from the gaming establishment line of credit complies with the spending control associated with the gaming establishment line of credit,
responsive to the determination being that the requested activation of the first amount of funds from the gaming establishment line of credit complies with the spending control associated with the gaming establishment line of credit, communicating, via the network interface and to the gaming establishment credit system, data that results in the gaming establishment credit system activating the first amount of funds from the gaming establishment line of credit, and
responsive to the determination being that the requested activation of the first amount of funds from the gaming establishment line of credit fails to comply with the spending control associated with the gaming establishment line of credit, reducing a risk of default associated with the gaming establishment line of credit by communicating, via the network interface and to the gaming establishment credit system, data that results in the gaming establishment credit system not activating the first amount of funds from the gaming establishment line of credit.

13. The method of claim 12, wherein the request to activate the first amount of funds from the gaming establishment line of credit occurs in association with a gaming establishment device.

14. The method of claim 13, wherein the requested activation of the first amount of funds from the gaming establishment line of credit complying with the spending control associated with the gaming establishment line of credit is based on a gaming establishment channel of commerce of the gaming establishment device.

15. The method of claim 14, wherein the requested activation of the first amount of funds from the gaming establishment line of credit complying with the spending control associated with the gaming establishment line of credit is based on a comparison of the first amount of funds to a second amount of funds associated with the gaming establishment channel of commerce of the gaming establishment device.

16. The method of claim 12, further comprising, responsive to the requested activation of the first amount of funds from the gaming establishment line of credit not complying with the spending control associated with the gaming establishment line of credit, communicating, via the network interface and to the gaming establishment credit system, data that results in an offer, by the gaming establishment credit system, of a second, different amount of funds from the gaming establishment line of credit, the second, different amount of funds from the gaming establishment line of credit complying with the spending control associated with the gaming establishment line of credit.

17. The method of claim 16, wherein an acceptance of the offer of the second, different amount of funds from the gaming establishment line of credit results in an activation of the second, different amount of funds from the gaming establishment line of credit.

18. The method of claim 12, wherein activations of different amounts of funds from the gaming establishment line of credit are associated with different spending controls.

19. The method of claim 12, further comprising, responsive to the determination being that the requested activation of the first amount of funds from the gaming establishment line of credit complies with the spending control associated with the gaming establishment line of credit, causing a serial communication, in accordance with a slot accounting system protocol, of data associated with the activation of the first amount of funds from the gaming establishment line of credit to an electronic gaming machine.

20. The method of claim 12, further comprising, responsive to the determination being that the requested activation of the first amount of funds from the gaming establishment line of credit complies with the spending control associated with the gaming establishment line of credit, causing a serial communication, in accordance with a slot accounting system protocol, of data associated with the activation of the first amount of funds from the gaming establishment line of credit to a slot machine interface board associated with an electronic gaming machine.
